(19) United States
(12) Patent Application Publication
(10) Pub. No.: US 2025/0159272 A1
(43) Pub. Date: May 15, 2025

(54) TELEVISION (TV) PLATFORM LINKED WITH NON FUNGIBLE TOKEN (NFT) MARKET, AND CONTROL METHOD FOR SAME TV PLATFORM

(71) Applicant: LG ELECTRONICS INC., Seoul (KR)

(72) Inventors: Taehyun KIM, Seoul (KR); Byungsun PARK, Seoul (KR)

(73) Assignee: LG ELECTRONICS INC., Seoul (KR)

(21) Appl. No.: 18/835,553

(22) PCT Filed: Aug. 12, 2022
(86) PCT No.: PCT/KR2022/012122

§ 371 Date: Aug. 2, 2024

(30) Foreign Application Priority Data
Feb. 14, 2022 (KR) 10-2022-0019030

(51) Int. Cl. H04N 21/254; H04N 21/44; H04N 21/4725; H04N 21/4782; H04N 21/658

(52) U.S. Cl. CPC H04N 21/2542; H04N 21/44008; H04N 21/4725; H04N 21/4782; H04N 21/6581

(57) ABSTRACT

The present invention relates to a TV platform comprising: an output unit including a display unit and a sound output unit; a communication unit that performs a communication connection with an NFT market server and a broadcasting station server; a scene analysis unit that detects a feature point from a broadcast scene of broadcast content received from the broadcasting station server and output through the output unit; and a control unit that receives digital product-related data including identification information of a digital product and an access information of an NFT purchase page of the digital product, generates a database according to the digital product-related data, displays a graphic object indicating that there is a digital product related to the broadcast scene on the basis of a result of matching the feature point detected from the broadcast scene and pieces of digital product identification information included in the database, and performs an access to an NFT purchase page of a specific digital product on the basis of selection of a user regarding the graphic object.

### TECHNICAL FIELD

The present disclosure relates to a television (TV) platform including a display unit configured to display image information, and more particularly, to a TV platform linked with a nun-fungible token (NFT) market to allow to purchase digital artwork.

### BACKGROUND ART

Generally, a TV may refer to a device that receives and displays broadcast content through radio waves, or receives and outputs image information and sound information. As functions of the TV are diversifying recently, the TV is implemented in a form of a multimedia device (a multimedia player) with complex functions including network functions such as an Internet access function, a web browsing function, etc. in addition to a function of playing content (broadcast content) received through broadcasting.

In addition, as communication technology advances recently, a regional limit to providing broadcast content has disappeared, and thus, an influence of broadcast content is expanding beyond the regional limit to the world. Accordingly, a market for products related to broadcast content is also expanding beyond regional limits to the world, and in a case of highly popular broadcast content, there is a need for customers to purchase digital products related to the broadcast content around the world. According to the customers' need, researches on a method for guiding the customers to easily and quickly search for digital products related to broadcast content and allowing customers who found desired digital products to easily and conveniently purchase the found digital products are currently being actively conducted.

Further, with development of TV-related technology, a TV device is developing into a comprehensive audio-visual platform, i.e., a TV platform connected to a server or other devices through a network to be capable of controlling and managing video or audio information output from the TV device through the connected network like video on demand (VOD) services, as well as providing a function of simply receiving and playing images, videos, or broadcasting signals. Owing to this development, researches on a method for utilizing the TV platform to purchase digital products related to broadcast content are currently being actively conducted.

### DISCLOSURE OF INVENTION

### Technical Problem

Therefore, to obviate those problems, an aspect of the detailed description is to provide a television (TV) platform and a method of controlling the same, the TV platform being configured to, while a user is watching broadcast content being played through a TV, allow the user to easily and quickly purchase a digital product related to the broadcast content being played.

In addition, an aspect of the detailed description is to provide a TV platform and a method of controlling the same, the TV platform configured to be linked with a non-fungible toke (NFT) market which allows to purchase ownership of a digital product so that, when a user selects a digital product related to broadcast content being watched by the user, the user may purchase the selected digital product through the NFT market.

### Solution to Problem

To achieve these and other advantages and in accordance with the purpose of the present disclosure, as embodied and broadly described herein, there is provided a television (TV) platform including: an output unit including a display unit and a sound output unit; a communication unit configured to perform a communication connection between a non-fungible token (NFT) market server and a broadcasting station server; a scene analysis unit configured to detect at least one feature point from a broadcast scene of broadcast content received from the broadcasting station server and output through the output unit; and a control unit configured to: receive, from the NFT market server, a plurality of pieces of digital product-related data including identification information of a digital product and access information of an NFT purchase page that allows to purchase an NFT for the digital product, and generate a database according to the received plurality of pieces of digital product-related data; and display a graphic object indicating that a digital product related to the broadcast scene is present on the display unit, based on a result of matching the at least one feature point detected from the broadcast scene with pieces of digital product identification information included in the database, and perform an access to an NFT purchase page of a specific digital product based on selection by a user with respect to the graphic object.

In one embodiment, when the TV platform is executed, the control unit may activate an NFT market application on a background, and receive the plurality of pieces of digital product-related data from the NFT market server through the activated NFT market application.

In one embodiment, when a pre-generated database is present, the control unit may transmit version information of the pre-generated database to the NFT market server through the activated NFT market application and update the pre-generated database by receiving update data for updating the pre-generated database in response to the transmitted version information.

In one embodiment, the control unit may be configured to: generate a plurality of databases corresponding to characteristics of different pieces of broadcast content, respectively, based on the received plurality of pieces of digital product-related data, and select at least one database corresponding to a characteristic of the received broadcast content, among the plurality of databases, and detect whether digital product identification information corresponding to the at least one feature point detected from the broadcast scene is present, based on the selected at least one database.

In one embodiment, when the received broadcast content is changed, the control unit may analyze a characteristic of broadcast content obtained as a result of the changing, and re-select at least one database corresponding to the broadcast content having the analyzed characteristic.

In one embodiment, in such a case that a broadcast channel is changed, when broadcast content of a broadcast channel obtained as a result of the changing is output for a certain period of time or longer, the control unit may determine that the received broadcast content is changed to the broadcast content of the broadcast channel obtained as a result of the changing.

In one embodiment, the characteristic of the received broadcast content may be at least one selected from a type of the received broadcast content, a broadcasting station server configured to provide the received broadcast content, and a broadcast channel through which the received broadcast content is received.

In one embodiment, the at least one feature point detected from the broadcast scene may be at least one selected from a character, an object, and a geographical feature each appearing in the broadcast scene, and a geographical location which is a background of the broadcast scene.

In one embodiment, the scene analysis unit may detect the at least one feature point from the broadcast scene, based on at least one selected from broadcast program information corresponding to the received broadcast content, identification information of the character appearing in the broadcast scene, dialogue information and commentary information in the broadcast scene, and a landmark detected from the background of the broadcast scene.

In one embodiment, the plurality of pieces of digital product-related data may further include an NFT drop object which is a graphic object including identification information of the specific digital product, and the control unit may display the NFT drop object as the graphic object indicating that the digital product related to the broadcast scene is present, based on the result of matching the at least one feature point with the pieces of the digital product identification information included in the database.

In one embodiment, the control unit may display the NFT drop object for preset limited time, and the preset limited time for which the NFT drop object may be displayed is determined differently depending on a type of the received broadcast content.

In one embodiment, the TV platform may be further connected to an external input device configured to provide an input by a user to the TV platform, and determine whether selection of the graphic object by the user is present, based on the user input applied via the external input device.

In one embodiment, the external input device may be configured to: include at least one selected from a preset key, a motion detection sensor, and a biometric information detection sensor, and provide a user input for selecting the graphic object to the TV platform, based on a result of detection by the motion detection sensor or the biometric information detection sensor, or whether the preset key is input.

In one embodiment, the specific digital product may be a digital product corresponding to the pieces of digital product identification information included in the database and matched with the at least one feature point detected from the broadcast scene, and the NFT purchase page may be a web page including information related to NFT ownership of the specific digital product and NFT price information of the specific digital product.

In addition, according to one aspect of the present disclosure, there is also provided a method of controlling a television (TV) platform includes: activating a non-fungible token (NFT) market application on a background when the TV platform is executed; receiving a plurality of pieces of digital product-related data including identification information of a digital product and access information about an NFT purchase page of the digital product from an NFT market server through the activated NFT market application; generating a database according to the received plurality of pieces of digital product-related data; receiving and outputting broadcast content from a broadcasting station server; detecting at least one feature point from a broadcast scene of the output broadcast content; detecting digital product identification information corresponding to the at least one feature point detected from the broadcast scene, by matching the at least one feature point detected from the broadcast scene with digital product identification information included in the database; when the digital product identification information corresponding to the at least one feature point detected from the broadcast scene is present as a result of the detecting, displaying a graphic object indicating that a digital product related to the broadcast scene is present; based on selection of the graphic object by a user, accessing an NFT purchase page that allows to purchase an NFT for a specific digital product according to access information corresponding to the detected digital product identification information; and performing a process of purchasing the NFT for the specific digital product based on an input by the user to the accessed NFT purchase page.

### Advantageous Effects of Invention

Hereinafter, a television (TV) platform according to the present disclosure and a method of controlling the same are described.

According to at least one of embodiments of the present disclosure, when a user wants to purchase a digital product among digital products related to broadcast content being played on the TV platform, a purchase transaction according to a purchase process in a non-fungible token (NFT) market may be transmitted to the NFT market through the TV platform to allow the user to immediately purchase the digital product that the user wants through the TV platform.

The present disclosure may allow a user to immediately purchase a digital product related to broadcast content being played when a user wants to purchase the digital product while watching the broadcast content on the TV platform so that the user may conveniently purchase a desired digital product of broadcast content without having to search for the desired digital product.

### BRIEF DESCRIPTION OF DRAWINGS

FIG. 1 is a block diagram illustrating a structure of a non-fungible token (NFT) market system according to an embodiment of the present disclosure, the NFT market system including an NFT market server and a television (TV) platform linked with the NFT market server.

FIG. 2 is a block diagram illustrating a structure of the TV platform according to an embodiment of the present disclosure.

FIG. 3 illustrates an example of an external input device connected to the TV platform according to an embodiment of the present disclosure.

FIG. 4 is a flowchart illustrating an operation process of purchasing a digital product related to broadcast content being played, on the TV platform according to an embodiment of the present disclosure.

FIG. 5 is a flowchart illustrating an operation process in which the TV platform according to an embodiment of the present disclosure selects one NFT drop database (DB) according to broadcast content being played, among a plurality of NFT drop DBs.

FIG. 6 illustrates an example of outputting, by the TV platform according to an embodiment of the present disclosure, an NFT drop object related to broadcast content being played according to a result of matching broadcast scenes.

FIG. 7 illustrates an example of purchasing an NFT corresponding to an NFT drop object selected by a user, through the TV platform according to an embodiment of the present disclosure.

### MODE FOR THE INVENTION

It is noted that the technical terms used herein are used only to describe specific embodiments and are not intended to limit the disclosure. In addition, a singular expression used herein may include a plural expression unless it represents a definitely different meaning from the context. In general, a suffix such as “module” and “unit” may be used to refer to elements or components. Use of such a suffix herein is merely intended to facilitate description of the specification, and the suffix itself is not intended to give any special meaning or function.

In the present disclosure, the terms “comprising” and “including” should not be construed to necessarily include all of the elements or steps disclosed herein, and should be construed not to include some of the elements or steps thereof, or should be construed to further include additional elements or steps.

In addition, in describing the present disclosure, if a detailed explanation for a related known function or construction is considered to unnecessarily divert the gist of the present disclosure, such explanation has been omitted but would be understood by those skilled in the art.

The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings. In addition, each of the embodiments described below, as well as combinations of embodiments, are changes, equivalents, or substitutes included in the technical scope of the present disclosure, and may fall within the technical scope of the present disclosure.

Hereinafter, embodiments disclosed in this specification will be described in detail with reference to the accompanying drawings.

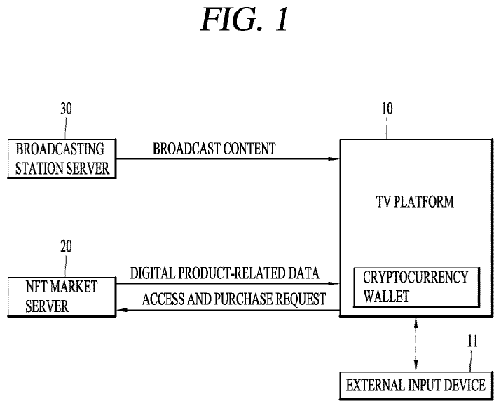

FIG. 1 is a block diagram illustrating a structure of a non-fungible token (NFT) market system according to an embodiment of the present disclosure, the NFT market system including an NFT market server and a television (TV) platform linked with the NFT market server.

Referring to FIG. 1, the NFT market system according to an embodiment of the present disclosure may include an NFT market server 20, a broadcasting station server 30, and a TV platform 10.

The broadcasting station server 30 may provide various broadcast content such as dramas, movies, commercial films (CFs), advertisements, documentaries, public videos, interviews, discussion content, and news or articles. For example, the broadcasting station server 30 may include a terrestrial broadcasting station that broadcasts the broadcast content through a terrestrial broadcasting system. Alternatively, the broadcasting station server 30 may be a cable broadcasting station that broadcasts the broadcast content through a cable broadcasting system. Alternatively, the broadcasting station server 30 may be an Internet protocol (IP) broadcasting station that provides the broadcast content through an IP network. Alternatively, the broadcasting station server 30 may be a public TV network that provides the broadcast content using sky waves.

Meanwhile, the NFT market server 20 may be a server that provides an NFT marketplace. The NFT Marketplace is a virtual space in which NFTs for digital products may be sold or purchased, and may refer to an e-commerce space in which digital products generated by artists or multiple individual sellers may be uploaded to be sold, and the uploaded digital products may be purchased by multiple purchasers.

Here, the digital products may mean all products that may be produced, distributed, consumed, and even stored in a digital form, e.g., images such as still images or moving images, sound such as music or sound of natural or artificial objects, etc. each playable on an electronic device.

Here, such digital products may be sold or purchased using the NFTs. An NFT stands for non-fungible token, which means ‘an irreplaceable token’ and may refer to a token that represents a digital asset with scarcity. An NFT certifies ownership of a digital product and verifies that ownership of the digital product is uniquely held by a person who owns the NFT. That is, the NFT means a token that verifies an owner of a digital asset.

The NFT may be configured such that a data block in which information regarding ownership and sale history is stored based on a blockchain is distributively stored in a plurality of terminals constituting a blockchain network through the blockchain network. Thus, counterfeiting, falsification, etc., may be prevented, and an original issuer may be confirmed at any time. However, unlike a cryptocurrency generally using a blockchain, since NFTs have a separate and unique recognition value, the NFTs cannot be exchanged with each other and are irreplaceable. Due to an irreplaceable and unique recognition value, the NFTs may provide a virtual asset with values of scarcity and uniqueness. The NFTs are used to sell or purchase digital products that may be generated using a digitalization method, such as an image, sound, a game item, etc.

Meanwhile, according to a request by the TV platform 10, the NFT market server 20 may transmit information related to digital products with respect to at least one piece of broadcast content to the TV platform 10. Here, the digital product-related information provided by the NFT market server 20 may be data for generating a database including identification information corresponding to at least one digital product and address information of a web page in which an NFT for the at least one digital product corresponding to the identification information may be purchased. Therefore, the TV platform 10 may generate a database including identification information corresponding to at least one digital product and web page address information corresponding to each of the identification information, based on data received from the NFT market server 20.

Here, a plurality of pieces of identification information may correspond to one digital product. In this case, the TV platform 10 may generate a database including the plurality of pieces of identification information corresponding to the one digital product.

Meanwhile, the at least one digital product may be a digital product related to broadcast content currently being played on the TV platform 10. That is, when broadcast content is played, the TV platform 10 may request the NFT market server 20 for digital product-related data regarding the played broadcast content. In response to the request by the platform 10, the NFT market server 20 may further transmit data regarding the at least one digital product. Then, the TV platform 10 may add the further transmitted data to a pre-generated database to update the pre-generated database. Conversely, the TV platform 10 may delete at least some data from an existing database based on data received from the NFT market server 20. Alternatively, an existing database may be deleted and a new database including only newly received data may be generated.

As an example, the TV platform 10 may delete, from an existing database, data that does not match newly received data. Then, the existing database may be updated by adding the newly received data to the existing database. To update a database, the NFT market server 20 may provide database version information together with transmitted data, and only different data according to respective versions may be transmitted as update data for updating the database. In this case, when a pre-generated database is present, the TV platform 10 may transmit version information of the pre-generated database to the NFT market server 20 and update the pre-generated database by receiving only update data according to the version information.

Meanwhile, the TV platform 10 may include a plurality of databases. For example, the databases may include a plurality of different databases according to types of broadcast content (e.g., a genre), a channel of the broadcast content, or time at which the broadcast content is played. To do so, the TV platform 10 may request the NFT market server 20 for data for generating different databases for respective types or channels of different pieces of broadcast content or time at which the different pieces of broadcast content are played, and the NFT market server 20 may provide the data according to the requesting.

Meanwhile, when a purchase request for an NFT for a specific digital product is received from the TV platform 10, the NFT market server 20 may proceed with an NFT transaction of the specific digital product according to the purchase request. Then, when the NFT transaction is completed, NFT status information of the specific digital product after being sold may be updated based on the NFT transaction included in the purchase request. To do so, the NFT market server 20 may transmit, to a blockchain network, transaction information for updating NFT information of the specific digital product for which the transaction has been completed, and update an NFT status of the specific digital product based on the transaction information. Then, information about the updated NFT status of the specific digital product may be received from the blockchain network, and the received NFT status information may be transmitted to the TV platform 10.

Accordingly, a user of the TV platform 10 may check a specific digital product of an NFT purchased by the user based on received NFT status information, and play the digital product through the TV platform 10 or sell the NFT for the purchased digital product through the NFT market server 20.

Meanwhile, the TV platform 10 according to an embodiment of the present disclosure may receive and play broadcast content provided by the broadcasting station server 30. A user may play broadcast content provided by the broadcasting station server 30 corresponding to a channel selected through the TV platform 10. In this case, when the user changes the channel, the TV platform 10 may receive broadcast content from another broadcasting station server according to the changed channel. That is, different broadcast content from different broadcasting station servers may be received and played depending on selection of a channel by the user. In addition, when broadcast content is received and played as described above, the TV platform 10 may request the NFT market server 20 for data for generating a database related to at least one digital product with respect to the broadcast content received and being played currently.

Meanwhile, when broadcast content received from the broadcasting station server 30 according to a selected channel is played, the TV platform 10 may analyze a scene (a broadcast scene) of the played broadcast content. Here, the broadcast scene refers to a particular broadcast content scene, i.e., a scene, and may mean a broadcast screen currently being broadcast on the TV platform 10. In addition, the TV platform 10 may analyze the broadcast scene by detecting information related to people, objects, places, terrain, or the like included in the broadcast scene.

Additionally, the TV platform 10 may determine whether a digital product related to the broadcast scene currently being broadcast is present, based on information detected from the analyzed broadcast scene and a database constituted by data received from the NFT market server 20. For example, the TV platform 10 may match the information detected from the analyzed broadcast scene with digital product identification information in the database. Then, as a result of the matching, when digital product identification information corresponding to the information detected from the broadcast scene is present, the TV platform 10 may determine that a digital product related to the broadcast scene currently being broadcast is present, and display the presence of the related digital product through a preset graphic object.

Here, the graphic object may be a graphic object displayed, for a limited time according to a preset condition, on a part of a display area in which broadcast content is played. Then, the displaying may be ended after the limited time elapses. That is, the graphic object may be a drop-type graphic object displayed only for a designated time. In this case, considering that transaction of a digital product is performed by using an NFT as described above, based on an NFT indicating a digital product and a method of displaying a graphic object (a drop type), hereinafter, the graphic object displayed for a limited time according to output of a broadcast scene is referred to as an NFT drop object.

When NFT drop objects are displayed, the respective NFT drop objects may be configured differently depending on corresponding digital products so that a user may identify digital products for the displayed NFT drop objects. Particularly, as described above, an NFT drop object of a digital product corresponding to a result of analyzing a broadcast scene may include identification information of the digital product that matches the NFT drop object so that a user may identify which element of the result of analyzing the broadcasting scene matches the corresponding digital product.

Meanwhile, as described above, NFT drop objects may correspond to digital products related to broadcast content currently being played, respectively. Thus, the NFT drop objects may be generated by manufacturers of the respective digital products and provided together with the digital products. Therefore, when data of at least one digital product (e.g.: data including identification information of the at least one digital product and address information about a web page in which an NFT for the at least one digital product may be purchased) is transmitted upon request by the TV platform 10, the NFT market server 20 may further transmit an NFT drop object respectively corresponding to the at least one digital product. That is, digital product-related data provided by the NFT market server 20 upon request by the TV platform 10 may be data including identification information corresponding to at least one digital product, address information of a web page in which an NFT for the at least one digital product may be purchased, and an NFT drop object corresponding to the at least one digital product. In addition, a database generated by the TV platform 10 based on digital product-related data provided by the NFT market server 20 is referred to as a NFT drop database (DB).

Meanwhile, when the NFT drop object is displayed, the TV platform 10 may detect whether the displayed NFT drop object is selected by a user. Then, based on a result of the detection, a purchase request for purchasing an NFT for a digital product corresponding to the NFT drop object may be transmitted to the NFT market server 20. To do so, the TV platform 10 may access a web page corresponding to address information of an NFT purchase page included in an NFT drop DB. In addition, a transaction for requesting to purchase the NFT for the digital product may be generated upon a request by the user.

Here, the transaction may include a signature proving that the transaction is requested from a genuine user. To do so, the TV platform 10 may be configured to include a cryptocurrency wallet in which a key for generating the signature is stored, or be connected to a module including the cryptocurrency wallet. Then, a transaction signed through the key stored in the cryptocurrency wallet is generated, and a purchase request including the signed transaction may be transmitted to the NFT market server 20.

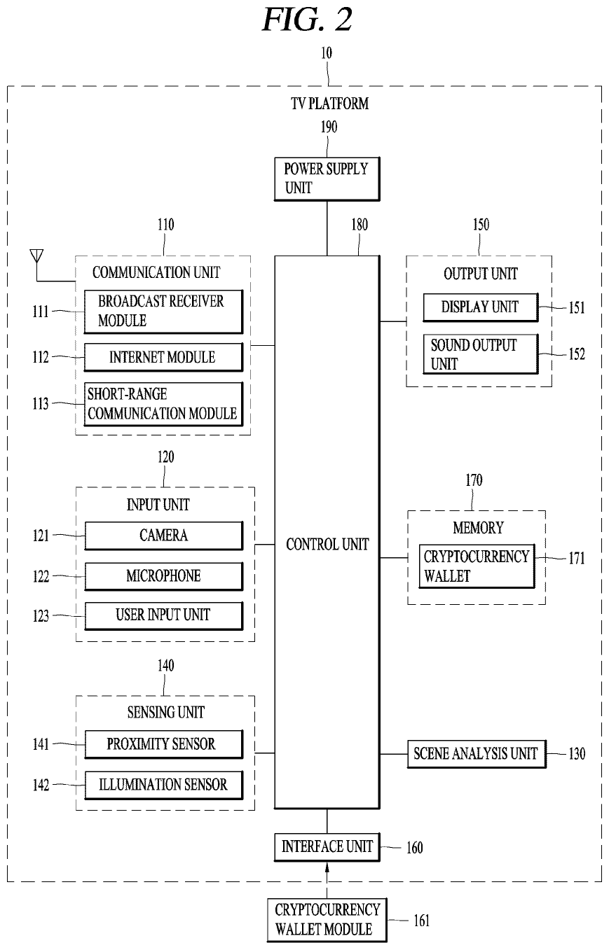

Hereinafter, a detailed structure of the TV platform 10 according to an embodiment of the present disclosure is described with reference to FIG. 2.

Meanwhile, the TV platform 10 may further include an external input device 11 configured to remotely control the TV platform 10. The external input device 11 may receive an input signal input by a user to perform power control, channel selection, screen settings, etc., and transmit a control signal corresponding to the received input signal to the TV platform 10. To do so, the TV platform 10 may be wiredly or wirelessly connected to the external input device 11.

Meanwhile, a selection signal by a user with respect to an NFT drop object displayed on a display unit of the TV platform 10 may be transmitted to the TV platform 10 through the external input device 11. To do so, the external input device 11 may include a preset key capable of directly selecting the displayed NFT drop object. When the user selects the preset key, the external input device 11 may transmit the selection signal for the NFT drop object to the TV platform 10. Then, the TV platform 10 may access an NFT purchase page of a digital product corresponding to the selected NFT drop object, and generate a purchase transaction for purchasing an NFT for the corresponding digital product according to a purchase request by the user through the accessed NFT purchase page.

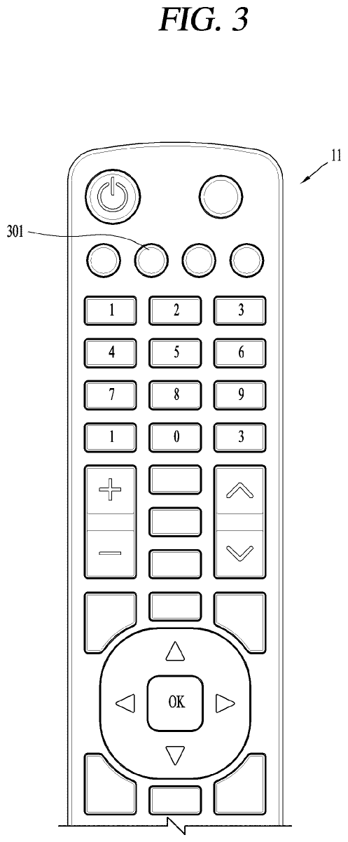

Hereinafter, the TV platform 10 of FIG. 1 is described in detail with reference to FIGS. 2 and 3.

FIG. 2 is a block diagram illustrating a structure of the TV platform 10 according to an embodiment of the present disclosure.

As illustrated in FIG. 2, the TV platform 10 according to an embodiment of the present disclosure may include a communication unit 110, an input unit 120, a scene analysis unit 130, a sensing unit 140, an output unit 150, an interface unit 160, a memory 170, a control unit 180, a power supply unit 190, etc. The components illustrated in FIG. 2 are not essential for implementing the TV platform 10, and the TV platform 10 described herein may include more or less components compared to the components described above.

In detail, among the components described above, the communication unit 110 may include one or more modules configured to allow wireless communication between the TV platform 10 and the broadcasting station server 30, or the TV platform 10 and a preset external server. The communication unit 110 may include at least one selected from a broadcast receiver module 111, a wireless Internet module 112, and a short-range communication module 113.

The broadcast receiver module 111 may receive a broadcast signal and/or broadcast-related information from a broadcasting station server through a broadcast channel. The broadcast receiver module 111 may include a tuner and a demodulator to receive radio frequency (RF) broadcast signals. That is, the broadcast receiver module 111 uses a tuner (not shown) to select an RF broadcast signal corresponding to a channel selected by a user, among RF broadcast signals received through an antenna, and converts the RF broadcast signal into an intermediate frequency signal or a baseband video/audio signal.

When the RF broadcast signal is a digital broadcast signal, the tuner may convert the RF broadcast signal into a digital intermediate frequency (IF) signal (DIF). On the other hand, when the RF broadcast signal is an analog broadcast signal, the tuner may convert the RF broadcast signal into an analog baseband video/audio signal (composite video banking sync (CVBS)/sound intermediate frequency (SIF)). As such, the tuner may be a hybrid tuner capable of processing a digital broadcast signal and an analog broadcast signal.

Meanwhile, the digital IF signal (DIF) output from the tuner may be input to the demodulator (not shown), and the analog baseband video/audio signal (CVBS/SIF) output from the tuner may be input to the control unit 180.

The tuner may receive a single-carrier RF broadcast signal according to an advanced television systems committee (ATSC) method or a multiple-carrier RF broadcast signal according to a digital video broadcasting (DVB) method.

Additionally, the broadcast receiver module 111 may include a plurality of tuners, for example, first and second tuners. In this case, the first tuner may receive a first RF broadcast signal corresponding to a broadcast channel selected by the user, and the second tuner may sequentially or periodically receive a second RF broadcast signal corresponding to a pre-stored broadcast channel. The second tuner may convert the RF broadcast signal into a digital IF signal (DIF) or an analog baseband video/audio signal (CVBS/SIF) by using a same method as that by the first tuner.

The demodulator may receive the digital IF signal (DIF) obtained as a result of the converting by the tuner and perform a demodulation operation. To do so, the demodulator may include a trellis decoder, a de-interleaver, a Reed-Solomon decoder, etc., or a convolution decoder, a de-interleaver, a Reed-Solomon decoder, etc., depending on whether the digital IF signal is based on the ATSC method or the DVB method.

The demodulator may perform demodulation and channel decoding, and then, output a stream (transport stream (TS)) signal. In this case, the stream signal may be a signal in which an image signal, a voice signal, and a data signal are multiplexed. A signal output from the demodulator may be input to the control unit 180, and demultiplexing, image/voice signal processing, etc. may be performed on the input signal.

Meanwhile, the broadcast receiver module 111 may receive a broadcast signal received through a wired cable. A signal received through the wired cable may be a stream signal in which an image signal, a voice signal, and a data signal each related to broadcast content are multiplexed. In this case, the broadcast receiver module 111 may input the stream signal to the control unit 180. Then, the control unit 180 may perform demultiplexing and image/voice signal processing on the input stream signal and output a result of performing the processing through the output unit 150.

The Internet module 112 refers to a module for wireless Internet access and may be equipped inside or outside the TV platform 10. Here, a wired Internet module may be configured to transmit/receive a wireless signal via a communication network according to wireless Internet technologies. In addition, the wireless Internet module may be configured to transmit/receive a wireless signal via a communication network according to wireless Internet technologies. The wireless internet technologies may include wireless local area network (WLAN) (wireless-fidelity (Wi-Fi)), wireless broadband (WiBro), world interoperability for microwave access (WiMAX), high speed downlink packet access (HSDPA), etc.

The Internet module may wiredly or wirelessly access the Internet according to at least one wired or wireless Internet technology within a scope including Internet technologies which are not described above, and be connected to at least one preset server through the Internet to transmit/receive data.

The short-range communication module 113 is used to perform short-range communication, and may support short-range communication using at least one selected from Bluetooth™, radio frequency identification (RFID), infrared data association (IrDA), ultra wideband (UWB), ZigBee, near field communication (NFC), Wi-Fi, Wi-Fi Direct, and wireless universal serial bus (USB) technologies.

The short-range communication module 113 may transmit, to the control unit 180, an image signal, a voice signal, and a data signal each provided by at least one other connectible external device. Additionally, the short-range communication module 113 may transmit an image signal, a voice signal, and a data signal of various media files stored in an external storage device such as a memory device, a hard disk, etc. to the control unit 180. Additionally, the short-range communication module 113 may transmit an image signal, a video signal, and a data signal processed by the control unit 180 to the at least one other external device or another external device.

Meanwhile, a digital signal output from the short-range communication module 113 may also include a stream signal. The stream signal may be a signal in which an image signal, a voice signal, and a data signal are multiplexed, as described above.

The input unit 120 may include one or more cameras 121 configured to input an image signal, a microphone (hereinafter, a mike) 122 configured to input an audio signal, and a user input unit 123 configured to receive an input of information from a user. Here, voice data or image data collected by the input unit 120 may be analyzed and processed according to a control command by a user.

The one or more cameras 121 may respectively acquire and process an image frame of a still image or a moving image obtained from one direction of the TV platform 10 through an image sensor. The processed image frame may be displayed on a display unit 151 or stored in the memory 170.

The microphone 122 may process an external sound signal into electrical voice data. The processed voice data may be variously utilized in accordance with a function which is being performed by the TV platform 10 (or an application program being executed). Various noise removal algorithms configured to remove noise generated in a process of receiving an input of the external sound signal may be implemented in the microphone 122.

The user input unit 123 is configured to receive an input of information from a user. When the information is input via the user input unit 123, the control unit 180 may control an operation of the TV platform 10 to correspond to the input information. The user input unit 123 may include a mechanical input unit (or a mechanical key, for example, a button located on a front, rear, or side surface of the TV platform 10, a dome switch, a jog wheel, a jog switch, etc.) and a touch type input unit.

Meanwhile, the scene analysis unit 130 may analyze a broadcast screen, that is, a broadcast scene, being currently output through the output unit 150. To do so, the scene analysis unit 130 may detect at least one person appearing in a current broadcast screen, that is, a broadcast scene, and detect information related to the detected at least one person. In addition, an object or a topographic feature corresponding to the broadcast scene may be detected, or a geographical location of terrain displayed through the broadcast scene may be detected.

As such, the scene analysis unit 130 may collect various information to detect a character, an object or a topographic feature, and a geographical location, etc. in the broadcast scene. For example, based on broadcasting program information (e.g.: an electronic program guide (EPG) and an interactive program guide (IPG)) of broadcast content received and being currently played and playing time of the broadcast content, the scene analysis unit 130 may detect feature information of a broadcast scene currently being played, such as a character, a topographic feature, an object, or a geographical location corresponding to the broadcast scene. Alternatively, sound information such as a character's dialogue or a commentary output through the sound output unit 152 may be identified, and feature information of the broadcast scene may be detected based on a result of the identification. Alternatively, the scene analysis unit 130 may identify a character in a broadcast scene through a feature point of a face, clothes, etc. of a character (e.g., a designation number or a name of a sports player, etc.), or identify a geographical location in the broadcast scene, etc. based on a landmark included in the broadcast screen.

In addition, the sensing unit 140 may include at least one sensor configured to sense at least one of peripheral environment information surrounding the TV platform 10 and user information. For example, the sensor unit 140 may include at least one of a proximity sensor 141 and an illumination sensor 142, and include at least one selected from a motion sensor, a red-green-blue (RGB) sensor, an infrared (IR) sensor, an ultrasonic sensor, an optical sensor, e.g. a camera (refer to the camera 121)), and a microphone (refer to the microphone 122).

The output unit 150 is configured to generate an output relevant to visual/audio information, and may include the display unit 151 and a sound output unit 152.

The display unit 151 displays (outputs) information processed by the TV platform 10. For example, the display unit 151 may output broadcast images according to various broadcast signals received through the broadcast receiver module 111. In addition, the display unit 151 may display at least one NFT drop object related to a broadcast image currently being output, that is, a broadcast scene on a designated area according to control by the control unit 180.

In addition, according to a request by the user, the display unit 151 may display execution screen information of an application program run in the TV platform 10, or user Interface (UI) or graphic user interface (GUI) information according to the execution screen information. As part of the UI or GUI information, the display unit 151 may display a screen of access to a web page according to an NFT drop object selected by a user. In addition, various information related to a purchase process performed based on an input by the user to a displayed web page may be displayed.

The sound output unit 152 may output audio data received from the communication unit 110 or stored in the memory 170. The sound output unit 152 may output audio signals related to functions performed by the TV platform 10 (e.g., an output of a broadcast image, an output of a digital product, etc.). To do so, the sound output unit 152 may include a speaker.

The interface unit 160 functions as a passage for various types of external devices connected to the TV platform 10. The interface unit 160 may include at least one selected from a wired/wireless headset port, a wired/wireless data port, a memory card port, a port which connects to a device equipped with an identification module, an audio input/output (I/O) port, a video I/O port, and an carphone port. In response to connection of an external device to the interface unit 160, the TV platform 10 may perform proper control related to the connected external device.

Meanwhile, the interface unit 140 may transmit a signal input by a user to the control unit 180 or transmit a signal transmitted from the control unit 180 to the user. To do so, the interface unit 140 may be connected to an external input device (e.g., a remote controller) (not shown) wiredly or wirelessly. Additionally, a user input signal input from a power key, a channel key, a volume key, a setting key, etc. through the connected external input device may be transmitted to the control unit 180. Here, the external input device may include at least one sensor configured to sense a gesture, a position, a touch, etc. of the user.

In addition, the memory 170 stores data supporting various functions of the TV platform 10. The memory 170 may store a plurality of application programs (or applications) run in the TV platform 10, information related to broadcast programs, or data and commands for operations of the TV platform 10. At least some of the application programs may be downloaded from an external server via wireless communication. In addition, at least some of the application programs may be present in the TV platform 10 from time of being released, to perform basic functions of the TV platform 10 (e.g., a broadcast signal reception function, a broadcast signal playback function, a broadcast program output function, etc.). The application programs may be stored in the memory 170 and installed in the TV platform 10 to be executed to perform an operation (or a function) designated by the control unit 180.

In addition to the operations related to application programs, the control unit 180 generally controls all operations of the TV platform 10. The control unit 180 may process signals or data received or input through the components described above, or process signals or data to be output. To do so, the control unit 180 may run an application program stored in the memory 170, output information according to a request by a user, or provide a function requested by the user.

In detail, when various data is received through the communication unit 110, the control unit 180 may control the output unit 150 to output image information and sound information according to the various data through the display unit 151 and the sound output unit 152. As an example, the control unit 180 may control the output unit 150 to output an image and sound of a particular broadcast channel through the broadcast receiver module 111, or control the output unit 150 to output multimedia data stored in an external device connected through the interface unit 160.

Alternatively, the control unit 180 may control the communication unit 110 to be connected to the NFT market server 20. In addition, the communication unit 110 may be controlled to receive an NFT drop DB for at least one digital product related to broadcast content currently output through the output unit 150 from the NFT market server 20. Then, when the NFT drop DB is received, the received NFT drop DB may be stored in the memory 170.

Here, the NFT drop DB may be updated by the NFT market server 20. For example, when received broadcast content is changed, the control unit 180 may request the NFT market server 20 for an NFT drop DB according to the changed broadcast content. Then, the control unit 180 may update a prestored NFT drop DB according to an NFT drop DB received from the NFT market server 20 in response to the request. Alternatively, the NFT market server 20 may transmit an NFT drop DB updated at a certain interval to the TV platform 10, and the control unit 180 may receive the updated NFT drop DB to update a prestored NFT drop DB.

Meanwhile, the control unit 180 may match a received NFT drop DB with a result of analysis performed by the scene analysis unit 130. In detail, the control unit 180 may match identification information corresponding to at least one digital product included in the NFT drop DB with the result of the analysis by the scene analysis unit 130 to detect whether a current broadcast scene includes feature information corresponding to the at least one broadcast scene. In addition, the display unit 151 may be controlled to display an NFT drop object corresponding to the at least one digital product corresponding to the detected feature information according to a result of the detection.

As such, when the NFT drop object is displayed, the control unit 180 may control the communication unit 110 to access an NFT purchase page in which an NFT for a specific digital product may be purchased based on a selection of the displayed NFT drop object by a user. In addition, when the NFT purchase page is accessed, a UI screen for the accessed NFT purchase page may be displayed on at least a part of the display unit 151. In addition, based on a user input to the UI screen, transaction information required by the NFT market server 20 to purchase the NFT for the specific digital product may be generated, and the generated transaction information may be transmitted to the NFT market server 20.

The transaction information may be transaction information including a transaction signature for verifying the user, that is, a signed transaction. In addition, the transaction signature may be generated based on a private key of the user. To do so, the memory 170 may include a cryptocurrency wallet 171 including the private key of the user and a public key. In addition, the control unit 180 may read the private key from the cryptocurrency wallet 171 to generate a transaction signature, and transmit a transaction including the transaction signature, i.e., a signed transaction to the NFT market server 20.

The cryptocurrency wallet 171 may be configured in a hardware type stored in a separate external module, instead of a software type stored in the memory 170. In this case, a cryptocurrency wallet module 171 including the cryptocurrency wallet may be connected to the control unit 180 through the interface unit 160. In addition, upon the connection of the cryptocurrency wallet module 171, the control unit 180 may read a private key from the cryptocurrency wallet module 171 and generate a transaction signature according to a request by the user. In addition, a transaction (a signed transaction) including a signature may be transmitted to the NFT market server 20.

The power supply unit 190 may be configured to receive external power or internal power and supply power needed for operation of respective components according to control by the control unit 180.

FIG. 3 illustrates an example of an external input device connected to the TV platform according to an embodiment of the present disclosure.

Referring to FIG. 3, keys disposed on the external input device 11 according to an embodiment of the present disclosure are shown. In addition, at least some of the keys may be used to purchase an NFT for a digital product according to an embodiment of the present disclosure.

As an example, a first key 301 may be a key for selecting an NFT drop object displayed on the display unit 151. In this case, when the first key 301 is selected by a user, the external input device 11 may transmit a selection signal for an NFT drop object to the TV platform 10. Then, the control unit 180 of the TV platform 10 may access an NFT purchase page corresponding to the NFT drop object selected according to an input of the first key 301. In addition, a UI screen of an accessed web page may be displayed on the display unit 151.

Meanwhile, the first key 301 may be a key further including another selectable function in addition to selection of an NFT drop object. In addition, one of a plurality of a plurality of functions corresponding to the first key 301 may be selected according to a period of time or a number of times for which the first key 301 is input, or intensity of an input of the first key 301.

Alternatively, a function corresponding to an input of the first key 301 may vary depending on an operating state of the TV platform 10. For example, when an NFT drop object is not displayed on the display unit 151, the TV platform 10 may perform a function related to playback of broadcast content based on an input of the first key 301, regardless of a purchase of an NFT for a digital product. On the other hand, when the first key 301 is input while an NFT drop object is displayed on the display unit 151, the TV platform 10 may access a web page (an NFT purchase page) for purchasing an NFT for a digital product corresponding to the NFT drop object based on the input of the first key 301. In addition, when the web page is accessed and the first key 301 is input while a UI screen of the accessed NFT purchase page is displayed, the TV platform 10 may end the access to the NFT purchase page based on the input of the first key 301. In this case, when the access to the NFT purchase page is ended, a screen of broadcast content may be displayed again in an area of the display unit 151 in which the UI screen of the NFT purchase page was displayed. That is, when an NFT drop object is displayed, the first key 301 may function as a toggle key for determining whether to access an NFT purchase page according to the displayed NFT drop object.

The configuration of the TV platform 10 according to an embodiment of the present disclosure and the external input device 11 capable of being connected to the TV platform 10 have been described above. Hereinafter, a process of operating the TV platform 10 to purchase an NFT for a digital product is described in detail with reference to a flowchart.

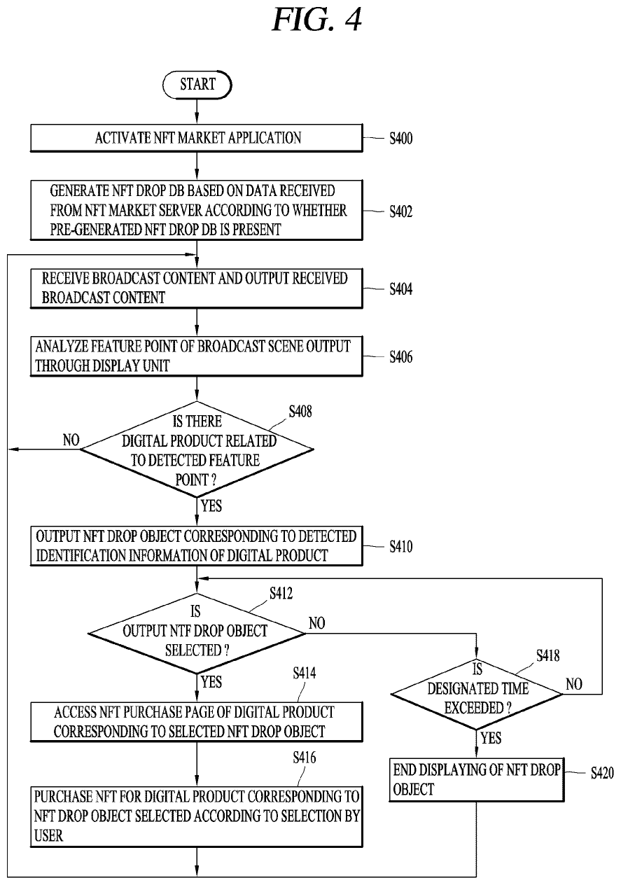

FIG. 4 is a flowchart illustrating an operation process of purchasing an NFT for a digital product related to broadcast content being played, on the TV platform according to an embodiment of the present disclosure.

Referring to FIG. 4, when power of the TV platform 10 is turned on, the control unit 180 may activate an NFT market application for connection between the TV platform 10 and the NFT market server 20 (S400). In this case, the NFT market application may be executed in a background.

When the NFT market application is activated in operation S400, the control unit 180 may determine whether a pre-generated NFT drop DB is present. According to whether a pre-generated NFT drop DB is present, digital product-related data for generating an NFT drop DB may be requested from the NFT market server 20 through the NFT market application activated in operation S400. Then, when the digital product-related data is received in response to the request, an NFT drop DB may be generated based on the received digital product-related data (S402).

Here, operation S402 may not be performed when a pre-generated NFT drop DB is present on the TV platform 10. Alternatively, operation S402 may include a process of, when a pre-generated NFT drop DB is present on the TV platform 10, transmitting version information of the pre-generated NFT drop DB to the NFT market server 20, and a process of, when the NFT market server 20 transmits the digital product-related data for updating the pre-generated NFT drop DB according to the version information, updating the pre-generated NFT drop DB based on the digital product-related data received from the NFT market server 20.

Accordingly, through operation S402, the TV platform 10 may include the NFT drop DB including information related to at least one digital product, i.e., identification information respectively corresponding to the at least one digital product, address information of an NFT purchase page respectively corresponding to the at least one digital product, and information about NFT drop objects respectively corresponding to the at least one digital product.

Then, the control unit 180 may receive broadcast content according to a channel selected by a user and output the received broadcast content (S404). Then, a feature point of a screen of the broadcast content currently being output, i.e., a broadcast scene may be analyzed (S406).

Here, the broadcast scene refers to a particular broadcast content scene, i.e., a scene, and may mean a scene of broadcast content is being currently broadcast on the TV platform 10 and displayed on a screen of the display unit 151. Alternatively, when the broadcast content is a drama or a movie, a scene may mean a series of situations or events that occur in a same background or location.

In addition, the feature point of the broadcast scene may mean at least one selected from a person, an object, a topographic feature, or a geographical location in the broadcast scene. For example, when broadcast content being output is a sports broadcast, a feature point of the broadcast scene may be a player or a team of players participating in a sports game. Alternatively, when the broadcast content being output is a movie or a drama, actors or actresses, costumes of actors or actresses, geographical features or geographical locations that serve as backgrounds for acting, etc. may be detected as a result of analyzing a feature point of the broadcast scene.

To analyze feature points of the broadcast scene, the control unit 180 may collect various information such as broadcasting program information (e.g.: EPG or IPG) of broadcast content, sound information such as a character's dialogue or a commentary, and a landmark included in the broadcast screen, and detect feature points of the broadcast scene based on the collected various information. In addition, the control unit 180 may detect feature points of the broadcast scene through face recognition or object recognition.

Then, the control unit 180 may determine whether a digital product related to the feature points of the broadcast scene detected in operation S406 is present, based on the pre-generated NFT drop DB (S408). As an example, the control unit 180 may detect whether identification information corresponding to the detected feature points of the broadcast scene, among identification information in the pre-generated NFT drop DB, is present.

Accordingly, when the currently output broadcast content is a sports broadcast and a play scene of a specific player is displayed on the display unit 151, the control unit 180 may identify a name of the specific player from an entry number or a face of the specific player whose play scene is displayed, or sports commentary information in operation S406. In addition, the identified player name may be detected as a feature point of a broadcast scene corresponding to the play scene. Then, the control unit 180 may search for presence of identification information of a digital product including the identified player name through the NFT drop DB described above with reference to operation S402. Then, based on a result of the searching, whether a digital product related to the detected feature point of the broadcast scene is present may be determined.

As a result of the determination in operation S408, when identification information of a digital product corresponding to the detected feature point of the broadcast scene is present, the control unit 180 may display, on one area of the unit 151, an NFT drop object corresponding to the identification information of the digital product, from the NFT drop DB (S410).

Here, the NFT drop object may include information corresponding to the feature point of the broadcast scene so that the user may identify the feature point of the broadcast scene. As an example, when the play scene of the specific player is displayed on the display unit 151 as described above, the control unit 180 may display an NFT drop object on one area of the display unit 151, the NFT drop object including at least one piece of feature information of a detected broadcast scene, i.e., a name or a signature of the specific player or information which enables to identify the specific player (e.g., a face image of the specific player).

Meanwhile, when the NFT drop object is displayed on one area of the display unit 151, the control unit 180 may determine whether the displayed NFT drop object is selected by a user (S412). For example, when a preset input is applied from the user, the control unit 180 may determine that the NFT drop object is selected by the user. Here, the preset input by the user may be a preset key input, a preset gesture, or an input of preset authentication information.

As an example, the control unit 180 may detect a gesture of the user from the user's image detected through the camera 121. In addition, when the gesture of the user detected through the camera 121 corresponds to a preset gesture, it may be determined that the NFT drop object is selected by the user. Alternatively, the preset gesture may be determined based on movement of the external input device 11. That is, when the user performs a preset gesture while holding the external input device 11, the external input device 11 may detect movement according to the preset gesture by the user, based on a detection value detected from at least one motion detection sensor such as a gyroscope, an acceleration sensor, etc. Then, when the detected movement matches the movement corresponding to the preset gesture, the external input device 11 may determine that the user has performed the preset gesture, and determine that the NFT drop object is selected by the user.

Alternatively, when the preset authentication information is input, the control unit 180 may determine that the NFT drop object is selected by the user. For example, when biometric information such as the user's voice information input through the microphone 122 or the user's fingerprint information detected from the external input device 11 held by the user's hand is detected, the control unit 180 may determine that the NFT drop object is selected by the user. To do so, the external input device 11 may include at least one sensor configured to detect the biometric information of the user.

Alternatively, when a preset key is input, the control unit 180 may determine that the NFT drop object is selected by the user. Here, the preset key may be one of keys on the user input unit 123 included in the TV platform 10. Alternatively, the preset key may be any one of the keys included in the external input device 11 as shown in FIG. 3. In this case, when a selection of the preset key by the user (e.g.: a key input) is detected from the user input unit 123 or the external input device 11, the control unit 180 may determine that the NFT drop object is selected by the user.

Meanwhile, as a result of the determination in operation S412, when the NFT drop object is not selected by the user, the control unit 180 may determine whether time that has clapsed since the NFT drop object was displayed exceeds designated time (S418). When the time that has elapsed since the NFT drop object was displayed is less than the designated time, operation S412 may be performed again to determine whether the NFT drop object is selected by the user. However, when the NFT drop object is not selected by the user until the designated time is exceeded, the control unit 180 may end the displaying of the NFT drop object (S420). Then, the control unit 180 may proceed back to operation S404 to output a broadcast screen according to the received broadcast content on the display unit 151.

Meanwhile, the designated time in operation S418 may be determined differently depending on a type of broadcast content being output or characteristics of a broadcast scene. For example, like a movie or a drama, when images captured in a same place or background or in a same space for a certain period of time constitute one broadcast scene, the designated time may be time corresponding to time for which the broadcast scene is output onto a screen That is, while the images captured for a certain period of time in the same place or background or the same space are output via the display unit 151, an NFT drop object related to the broadcast scene may be displayed.

On the other hand, in a case when a particular event (e.g.: appearance of a specific player or a play of a specific player) constitutes a broadcast scene like sports broadcasting, the control unit 180 may maintain a state of displaying the NFT drop object for a certain period of time. This is because when a broadcast scene is constituted by an event that occurs irregularly like sports broadcasting, time for outputting the broadcast scene may be too short, and therefore, when displaying of the NFT drop object is ended too quickly, a user may not easily purchase an NFT for a digital product related to the broadcast scene. Accordingly, while a screen of broadcast content such as sports broadcasting is output, even when a broadcast scene corresponding to an NFT drop object is no longer displayed on a screen, the control unit 180 may maintain a state in which the NFT drop object is output for preset minimum time.

Meanwhile, as a result of the determination in operation S412, when the displayed NFT drop object is selected by the user, the control unit 180 may detect, from the NFT drop DB, an address of an NFT purchase page corresponding to the currently selected NFT drop object. Then, the detected NFT purchase page may be accessed (S414). Then, a UI screen of the currently accessed NFT purchase page may be displayed on at least a part of the display unit 151. To do so, the TV platform 10 may include a web browser capable of accessing a web page and displaying a UI screen of the web page, and display a screen of the web page (an NFT purchase page) accessed by the web browser on at least a part of the display unit 151.

Here, the NFT purchase page may include various information related to purchase of the digital product corresponding to the NFT drop object selected by the user. For example, the NFT purchase page is an NFT purchase page in which the NFT for the digital product may be purchased, and may be a web page provided in an NFT marketplace. That is, when the user selects an NFT drop object, the TV platform 10 may perform an access to the NFT market server 20, and access the NFT marketplace through the NFT market server 20.

Meanwhile, the NFT purchase page may include various information related to an NFT for a specific digital product. As an example, the NFT purchase page may include a name of a current owner (an owner of an NFT) of a digital product. In addition, NFT history information (history) including information about an original owner of the NFT and a previous owner of the NFT may be included. In addition, information about a price of the NFT for the digital product may be included.

As such, when various information related to the NFT for the digital product corresponding to the output NFT drop object is displayed, the control unit 180 may detect an input by the user to purchase the NFT for the digital product. In addition, when the input by the user is detected, the NFT for the digital product may be purchased (S416).

Here, the input by the user may be a preset key input, a preset gesture, or an input of preset authentication information. Here, the gesture may be detected from movement of the camera 121 in the TV platform 10 or the external input device 11. In addition, the preset authentication information may be input through the user input unit 123 or the microphone 122 of the TV platform 10, or a biometric information detection sensor disposed in the external input device 11. In addition, the preset key may be input through the user input unit 123 in the TV platform 10 or a particular key on the external input device 11.

When the input by the user is detected, the control unit 180 may generate a purchase transaction for purchasing an NFT for a digital product corresponding to the output NFT drop object. Then, the TV platform 10 may transmit the generated purchase transaction to the NFT marketplace. In this case, the purchase transaction may include a signature of an authenticated user, and when it is proved that the signature of the authenticated user is genuine, the purchase of the NFT according to the purchase transaction may be completed. Then, the NFT market server 20 may update an NFT status of the digital product by distributively storing NFT owner change history according to sale of the NFT in a plurality of terminals through the blockchain network.

Meanwhile, when the purchase of the NFT for the digital product is completed through operation S416, the control unit 180 may end the displaying of the NFT purchase page. Therefore, the access to the NFT purchase page may also be ended. Then, the control unit 180 may proceed to operation S404 to output a broadcast screen according to the received broadcast content on the display unit 151. Then, a process after operation S404 may be performed again.

Meanwhile, the TV platform 10 according to an embodiment of the present disclosure may include a plurality of NFT drop DBs. For example, the TV platform 10 may include a plurality of different NFT drop DBs corresponding to a type of broadcast content (e.g., a genre), a broadcasting station server providing the broadcast content, or a broadcast channel. In addition, as such, when the plurality of different NFT drop DBs respectively corresponding to a type of the broadcast content, a broadcasting station server, or a broadcast channel are included, the control unit 180 may select at least one NFT drop DB among the plurality of NFT drop DBs based on broadcast content currently output on the display unit 151, and output, onto the display unit 151, an NFT drop DB that matches a feature point of a broadcast scene based on the selected at least one NFT drop DB.

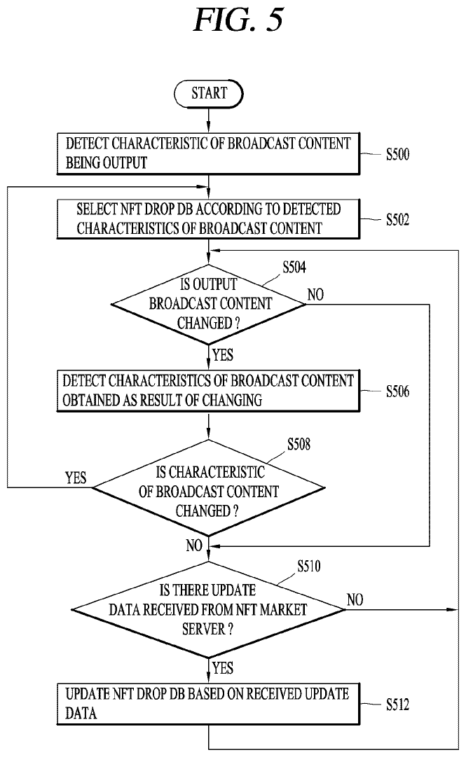

FIG. 5 is a flowchart illustrating an operation process in which the TV platform 10 according to an embodiment of the present disclosure selects one NFT drop DB according to broadcast content being played, when a plurality of NFT drop DBs are included.

Referring to FIG. 5, the control unit 180 of the TV platform 10 according to an embodiment of the present disclosure may detect characteristics of broadcast content being received and output. Here, the characteristics of the broadcast content may be a type of broadcast content being output, a channel of the broadcast content, or a broadcasting station server providing the broadcast content (S500). Then, the control unit 180 may select at least one NFT drop DB, corresponding to the characteristics of the broadcast content detected in operation S500, from a plurality of NFT drop DBs (S502).

In this case, the at least one NFT drop DB selected in operation S502 may be used to detect identification information of a digital product corresponding to the detected feature point of the broadcast scene in operation S408 of FIG. 4. In this case, when a plurality of NFT drop DBs are selected in operation S502, the control unit 180 may detect at least one NFT drop object corresponding to the feature point of the broadcast scene detected in operation S406 of FIG. 4, based on each of the plurality of NFT drop DBs selected in operation S502. Then, the detected NFT drop DB object may be output onto the display unit 151 of the TV platform 10 in operation S410 of FIG. 4.

Meanwhile, when the at least one NFT drop DB is selected in operation S502, the control unit 180 may check whether broadcast content output through the display unit 151 is changed (S504). Here, the change of the broadcast content means that broadcast content received to the TV platform 10 is changed, and may occur when a user changes a broadcast channel. In other words, operation S504 may be an operation of checking whether the user has changed the broadcast channel.

Here, in a case when the broadcast channel is changed, the control unit 180 may determine that the broadcast channel has been changed only when broadcast content of a broadcast channel obtained as a result of the changing is output for more than a certain period of time. Accordingly, when the user changes a broadcast channel for channel search, whether broadcast content is changed may not be checked with respect to broadcast content output through broadcast channels temporarily selected for the channel search.

As a result of the checking in operation in S504, when the broadcast channel is changed, the control unit 180 may detect characteristics of a broadcast content of a broadcast channel obtained as a result of the changing (S506). In this case, the control unit 180 may detect a type of the broadcast content received through the broadcast channel obtained as a result of the changing, a broadcasting station server providing the broadcast content, or the broadcast channel obtained as a result of the changing. Then, whether characteristics of the detected broadcast content are different from those of the broadcast content detected in operation S500 may be checked (S508). In addition, when the characteristics of the broadcast content are different, the control unit 180 may proceed back to operation S502 to select at least one NFT drop DB corresponding to the broadcast content obtained as a result of the changing.

For example, when a user changes a broadcast channel from a first channel to a second channel, both the first channel and the second channel may be sports broadcast channels. Accordingly, both the first channel and the second channel may be channels through which broadcast content related to sports broadcasting is output. Then, the control unit 180 may determine that the characteristics of the broadcast content are not changed in operation S508. In this case, the control unit 180 may not newly select an NFT drop DB.

In this case, the control unit 180 may check whether the broadcast content output through the first channel and the second channel both correspond to a same type of sports game. Then, only in a case when the first and second channels output broadcast content about a same type of sports game, it may be determined that characteristics of the broadcast content are not changed. Accordingly, when the broadcast content in the first channel is about a sports game different from that in the second channel, the control unit 180 may determine that characteristics of the broadcast content are changed, and proceed back to operation S502 to reselect at least one NFT drop DB corresponding to broadcast content obtained as a result of changing the broadcast channel.

Also, as described above, when a user changes a broadcast channel from the first channel to the second channel, although the first and second channels are different from each other, the first and second channels may be channels that transmit broadcast content from a same broadcasting station server. In this case, the control unit 180 may determine that the characteristics of the broadcast content are not changed in operation S508. Then, the control unit 180 may not newly select an NFT drop DB.

Meanwhile, when the broadcast content output in operation S504 is not changed, that is, when the broadcast channel is not changed or when characteristics of the broadcast content being output are not changed as a result of the determination in operation S508 although the broadcast content being output is changed, the control unit 180 may check whether update data for updating an NFT drop DB is received from the NFT market server 20 (S510). In addition, when the update data is not received, the control unit 180 may proceed back to operation S504 to check whether the broadcast content output through the display unit 151 is changed.

On the other hand, as a result of the checking in operation S510, when update data is received from the NFT market server 20, at least one of a plurality of pre-generated NFT drop DBs may be updated based on the received update data (S512). In this case, when an NFT drop DB corresponding to the update data is not present, a new NFT drop DB including the update data may be generated. In addition, the control unit 180 may proceed back to operation S504 to check whether the broadcast content output through the display unit 151 is changed.

Meanwhile, according to a result of the determination in operation S508, when operation S502 is performed again to select at least one new NFT drop DB according to the broadcast content obtained as a result of the changing, an NFT drop DB corresponding to the broadcast content obtained as a result of the changing may not be present in the TV platform 10. In this case, the control unit 180 may request the NFT market server 20 for digital product-related data according to characteristics of the broadcast content obtained as a result of the changing. Then, the control unit 180 may generate a new NFT drop DB based on digital product-related data received in response to the request, and the generated new NFT drop DB may be selected.

As such, when a plurality of NFT drop DBs are included and an NFT drop object is output based on one NFT drop DB determined according to broadcast content which is received and output, a size of an NFT drop DB in which identification information according to a feature point of a broadcast scene is to be searched for may be reduced. Accordingly, time needed to detect an NFT drop object corresponding to a feature point of a broadcast scene may be reduced. Thus, time needed to purchase an NFT for the digital product according to the operation process of FIG. 4 may be further reduced.

The operation process of the TV platform 10 has been described above in detail, the operation process being configured such that an NFT drop object indicating that a digital product related to a broadcast scene is present is output as a result of analyzing the broadcast scene through the TV platform 10 according to an embodiment of the present disclosure, and a user may purchase an NFT for a digital product related to the broadcast scene based on a selection by the user with respect to the NFT drop object.

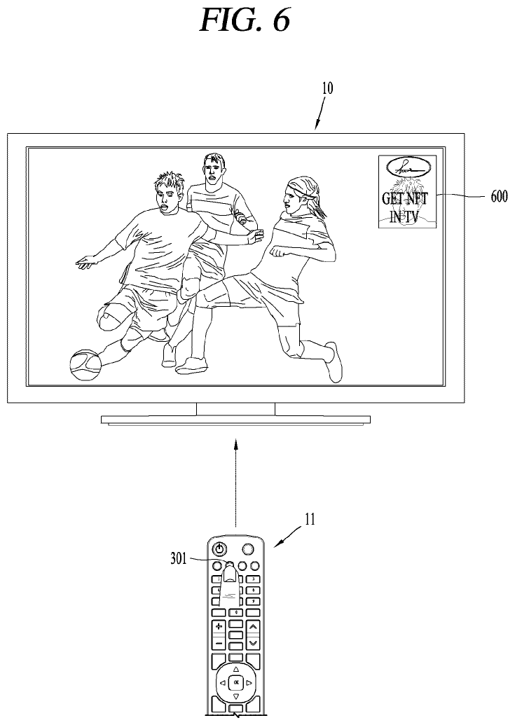

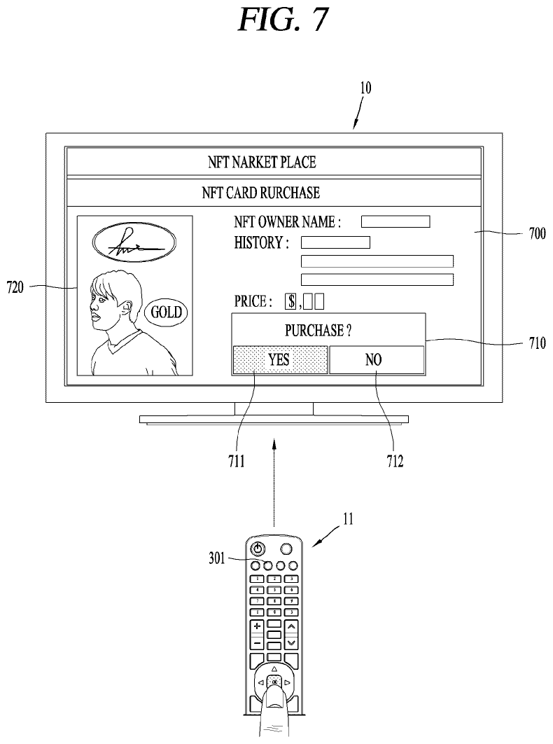

Hereinafter, an example of outputting an NFT drop object from the TV platform 10 according to an embodiment of the present disclosure, and purchasing an NFT for a digital product according to selection of the NFT drop object is described with reference to FIGS. 6 and 7.

FIG. 6 illustrates an example of outputting, by the TV platform 10 according to an embodiment of the present disclosure, an NFT drop object related to broadcast content being played according to a result of matching broadcast scenes.

Referring to FIG. 6, an example in which the TV platform 10 according to an embodiment of the present disclosure outputs broadcast content related to sports broadcasting according to a channel selected by a user is illustrated. In this case, the TV platform 10 may select at least one NFT drop DB corresponding to sports broadcasting (soccer) as characteristics of broadcast content broadcast in a currently selected channel, i.e., a type of the broadcast content.

As such, when at least one NFT drop DB according to characteristics of the broadcast content being output is selected, the control unit 180 of the TV platform 10 may analyze a broadcast scene output onto the display unit 151, that is, a broadcast scene. Accordingly, as shown in FIG. 6, when a play scene of a specific player is output through the display unit 151, the control unit 180 may detect a name of the player corresponding to the play scene, etc. based on a result of analyzing a broadcast scene including the play scene. In addition, digital product-related data corresponding to the detected name of the player may be detected from the selected at least one NFT drop DB.

As a result of the detection, when digital product-related data corresponding to the detected name of the player is present, the control unit 180 may output an NFT drop object 600 included in the detected digital product-related data onto the display unit 151. In this case, the NFT drop object 600 may include information about a relevant digital product. For example, when the relevant digital product is a player card including a handwritten signature of the specific player, the NFT drop object 600 may include an image related to the handwritten signature of the specific player.

In addition, the NFT drop object 600 may further include information that allows to identify a player corresponding to the displayed NFT drop object 600, among players appearing in the broadcast scene. As an example, as shown in FIG. 6, the NFT drop object 600 may further include a face image of the specific player to indicate that a digital product corresponding to the NFT drop object 600 is a product related to the specific player.

As such, when the NFT drop object 600 is displayed in one area of the display unit 151, the control unit 180 of the TV platform 10 may determine whether the user has selected the NFT drop object 600. As an example, as shown in FIG. 6, as the user selects a preset key 301 of the external input device 11, when an input signal corresponding to the preset key 301 is received from the external input device 11, the control unit 180 may determine that the user has selected the NFT drop object 600.

Meanwhile, when the user has selected the NFT drop object 600 output onto the display unit 151, the control unit 180 of the TV platform 10 may access an address of an NFT purchase page corresponding to the NFT drop object 600 to display a web page in which an NFT for a digital product corresponding to the NFT drop object 600 may be purchased, i.e., an NFT purchase page.

FIG. 7 illustrates an example in which the NFT purchase page is displayed on the TV platform 10 according to an embodiment of the present disclosure, and an example in which a user purchases an NFT for a digital product through the displayed NFT purchase page.

Referring to FIG. 7, when a web page according to the NFT drop object 600, i.e., an NFT purchase page is accessed, the TV platform 10 according to an embodiment of the present disclosure may display an accessed screen 700 of the NFT purchase page on at least a part of the display unit 151. In this case, as presented in the NFT purchase page accessed screen 700 of FIG. 7, the NFT purchase page may include various information related to an NFT for a digital product corresponding to the NFT drop object 600.

For example, as presented in the NFT purchase page accessed screen 700 of FIG. 7, the NFT purchase page may include a digital product 720 corresponding to the NFT drop object 600. In addition, information of a current owner (an NFT owner name) of an NFT for the corresponding digital product 720 may be included. In addition, information about history in which ownership of the corresponding digital product 720 is changed may be included. In addition, information about a price of the NFT for the digital product 720 may be included.

As such, when the NFT purchase page accessed screen 700 for the digital product corresponding to the NFT drop object 600 is displayed, the control unit 180 of the TV platform 10 may request to purchase the NFT for the digital product 720 according to a selection by the user. As an example, when a user selection such as an input of a designated key is present, the control unit 180 may display a purchase option menu 710 including an NFT purchase request 711 and a purchase cancellation 712 for the digital product 720 as shown in FIG. 7.

In addition, when the user selects the NFT purchase request 711 in the purchase option menu 710, the control unit 180 may generate a purchase transaction for purchasing an NFT for the digital product 20. Then, the generated purchase transaction may be transmitted to the NFT market server 20. Then, the NFT market server 20 may update an NFT status of the digital product 20 through a blockchain network to purchase the NFT for the digital product 20.

An example in which only one NFT drop object is displayed has been described above. However, when feature points detected in a broadcast scene match identification information corresponding to one or more digital products, the one or more NFT drop objects may be displayed on the display unit 151. In this case, the control unit 180 of the TV platform 10 may select one of a plurality of NFT drop objects output based on an input via the user input unit 123 or the external input device 11, or a gesture or a voice signal. Then, the TV platform 10 may access an NFT marketplace and output an NFT purchase page in which an NFT for a digital product corresponding to the selected one NFT drop object may be purchased.

Meanwhile, as described above, when the NFT for the digital product is purchased through the TV platform 10, the control unit 180 of the TV platform 10 may obtain information about the NFT for the digital product purchased by a user. Accordingly, the control unit 180 may determine whether identification information of a digital product corresponding to a feature point detected from a currently output broadcast scene is identification information of a digital product previously purchased by the user. In addition, as a result of the determination, when the identification information of the digital product corresponding to the feature point detected from the currently output broadcast scene is one of pieces of the identification information of the digital product previously purchased by the user, the control unit 180 may not display an NFT drop object corresponding to the digital product. That is, the control unit 180 may limit displaying of an NFT drop object corresponding to the digital product previously purchased by the user on the display unit 151 not to display the NFT drop object.

The present disclosure can be implemented as computer-readable codes on a medium having a program recorded thereon. The computer readable medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). The above detailed description should not be limitedly construed in all aspects and should be considered as illustrative. The scope of the present disclosure should be determined by reasonable interpretation of the appended claims, and all changes within the scope of equivalents of the present disclosure are included in the scope of the present disclosure.

What is claimed is:

1. A television (TV) platform comprising:
an output unit comprising a display unit and a sound output unit;
a communication unit configured to perform a communication connection between a non-fungible token (NFT) market server and a broadcasting station server;
a scene analysis unit configured to detect at least one feature point from a broadcast scene of broadcast content received from the broadcasting station server and output through the output unit; and
a control unit configured to:
receive, from the NFT market server, a plurality of pieces of digital product-related data comprising identification information of a digital product and access information of an NFT purchase page that allows to purchase an NFT for the digital product, and generate a database according to the received plurality of pieces of digital product-related data; and
display a graphic object indicating that a digital product related to the broadcast scene is present on the display unit, based on a result of matching the at least one feature point detected from the broadcast scene with pieces of digital product identification information comprised in the database, and perform an access to an NFT purchase page of a specific digital product based on selection by a user with respect to the graphic object.

2. The TV platform of claim 1, wherein, when the TV platform is executed, the control unit activates an NFT market application on a background, and receives the plurality of pieces of digital product-related data from the NFT market server through the activated NFT market application.

3. The TV platform of claim 2, wherein, when a pre-generated database is present, the control unit transmits version information of the pre-generated database to the NFT market server through the activated NFT market application and updates the pre-generated database by receiving update data for updating the pre-generated database in response to the transmitted version information.

4. The TV platform of claim 1, wherein the control unit is configured to:
generate a plurality of databases corresponding to characteristics of different pieces of broadcast content, respectively, based on the received plurality of pieces of digital product-related data, and
select at least one database corresponding to a characteristic of the received broadcast content, among the plurality of databases, and detect whether digital product identification information corresponding to the at least one feature point detected from the broadcast scene is present, based on the selected at least one database.

5. The TV platform of claim 4, wherein, when the received broadcast content is changed, the control unit analyzes a characteristic of broadcast content obtained as a result of the changing, and re-selects at least one database corresponding to the broadcast content having the analyzed characteristic.

6. The TV platform of claim 5, wherein, in such a case that a broadcast channel is changed, when broadcast content of a broadcast channel obtained as a result of the changing is output for a certain period of time or longer, the control unit determines that the received broadcast content is changed to the broadcast content of the broadcast channel obtained as a result of the changing.

7. The TV platform of claim 4, wherein the characteristic of the received broadcast content is at least one selected from a type of the received broadcast content, a broadcasting station server configured to provide the received broadcast content, and a broadcast channel through which the received broadcast content is received.

8. The TV platform of claim 1, wherein the at least one feature point detected from the broadcast scene is at least one selected from a character, an object, and a geographical feature each appearing in the broadcast scene, and a geographical location which is a background of the broadcast scene.

9. The TV platform of claim 8, wherein the scene analysis unit detects the at least one feature point from the broadcast scene, based on at least one selected from broadcast program information corresponding to the received broadcast content, identification information of the character appearing in the broadcast scene, dialogue information and commentary information in the broadcast scene, and a landmark detected from the background of the broadcast scene.

10. The TV platform of claim 1, wherein the plurality of pieces of digital product-related data further comprise an NFT drop object which is a graphic object comprising identification information of the specific digital product, and
the control unit displays the NFT drop object as the graphic object indicating that the digital product related to the broadcast scene is present, based on the result of matching the at least one feature point with the pieces of the digital product identification information comprised in the database.

11. The TV platform of claim 10, wherein the control unit displays the NFT drop object for preset limited time, and
the preset limited time for which the NFT drop object is displayed is determined differently depending on a type of the received broadcast content.

12. The TV platform of claim 1, wherein the TV platform is further connected to an external input device configured to provide an input by a user to the TV platform, and determines whether selection of the graphic object by the user is present, based on the user input applied via the external input device.

13. The TV platform of claim 12, wherein the external input device is configured to:
comprise at least one selected from a preset key, a motion detection sensor, and a biometric information detection sensor, and
provide a user input for selecting the graphic object to the TV platform, based on a result of detection by the motion detection sensor or the biometric information detection sensor, or whether the preset key is input.

14. The TV platform of claim 1, wherein the specific digital product is a digital product corresponding to the pieces of digital product identification information comprised in the database and matched with the at least one feature point detected from the broadcast scene, and
the NFT purchase page is a web page comprising information related to NFT ownership of the specific digital product and NFT price information of the specific digital product.

15. A method of controlling a television (TV) platform, the method comprising:
activating a non-fungible token (NFT) market application on a background when the TV platform is executed;
receiving a plurality of pieces of digital product-related data comprising identification information of a digital product and access information about an NFT purchase page of the digital product from an NFT market server through the activated NFT market application;
generating a database according to the received plurality of pieces of digital product-related data;
receiving and outputting broadcast content from a broadcasting station server;
detecting at least one feature point from a broadcast scene of the output broadcast content;
detecting digital product identification information corresponding to the at least one feature point detected from the broadcast scene, by matching the at least one feature point detected from the broadcast scene with digital product identification information comprised in the database;
when the digital product identification information corresponding to the at least one feature point detected from the broadcast scene is present as a result of the detecting, displaying a graphic object indicating that a digital product related to the broadcast scene is present;
based on selection of the graphic object by a user, accessing an NFT purchase page that allows to purchase an NFT for a specific digital product according to access information corresponding to the detected digital product identification information; and
performing a process of purchasing the NFT for the specific digital product based on an input by the user to the accessed NFT purchase page.
